(19) United States
(12) Patent Application Publication
(10) Pub. No.: US 2002/0034388 A1
(43) Pub. Date: Mar. 21, 2002

(54) Image printing apparatus and method of control thereof, and information processing device and method of control thereof

(76) Inventors: Kenichi Inadomi, Kanagawa (JP); Kazunori Arima, Kanagawa (JP); Toshiya Kondoh, Kanagawa (JP); Hiroyuki Horii, Kanagawa (JP); Koji Kawamura, Kanagawa (JP)

Correspondence Address: FITZPATRICK CELLA HARPER & SCINTO, 30 ROCKEFELLER PLAZA, NEW YORK, NY, 10112, US

(21) Appl. No.: 09/946,489

(22) Filed: Sep. 6, 2001

(30) Foreign Application Priority Data
Sep. 12, 2000 (JP) 2000-277077

(51) Int. Cl. G03B 17/48

(52) U.S. Cl. 396/429

(57) ABSTRACT

The present invention provides a printing apparatus and a method of controlling the same which can minimize power consumption and improve operability by performing a control according to a setting circumstance of a printing medium. To realize this, the printing apparatus comprises a detection means for detecting whether the printing medium is set and a control means for setting and/or canceling the print mode according to a result of detection by the detection means.

This application is based on Patent Application No. 2000-277077 filed Sep. 12, 2000 in Japan, the content of which is incorporated hereinto by reference.

### BACKGROUND OF THE INVENTION

1. Field of the Invention

The present invention relates to an image printing apparatus for printing an image on a printing medium and a method of controlling the same. More particularly, the present invention relates to an image printing apparatus capable of printing an image on a printing medium when an operation mode is set to a print mode, and also relates to a method of controlling the same.

Further, the present invention relates to an information processing device capable of printing an image on a printing medium and photographing an optical image, and also to a method of controlling the same. More specifically, the present invention relates to an information processing device capable of controlling the setting of an operation mode of the device and to a method of controlling the same.

2. Description of the Related Art

In conventional image printing apparatus, when a power is on, the apparatus is kept in a standby state of a print mode even if a printing medium, such as paper, is not set in the apparatus, i.e., the apparatus is waiting for a command from the user.

Because the conventional image printing apparatus is kept in the standby state of the print mode even when a printing medium is not set, i.e., a print operation cannot be executed, there is a problem that the electric power is wasted for keeping the apparatus in the standby state.

### SUMMARY OF THE INVENTION

An object of the present invention is to provide an image printing apparatus capable of minimizing power consumption and improving operability by performing a control according to whether a printing medium is set, and also to provide a method of controlling the same.

Another object of the present invention is to provide an information processing device capable of printing an image on a printing medium and photographing an optical image and still capable of minimizing power consumption and improving operability, and to provide a method of controlling the same.

In the first aspect of the present invention, there is provided an image printing apparatus capable of printing a image on a printing medium when an operation mode is selected as a print mode, comprising:

a detection means for detecting whether the printing medium is set; and

a control means for setting and/or canceling the print mode according to a result of detection by the detection means.

In the second aspect of the present invention, there is provided a method of controlling an image printing apparatus capable of printing a image on a printing medium when an operation mode is set as a print mode, comprising the steps of:

setting and/or canceling a print mode according to a result of detection as to whether the printing medium is set.

In the third aspect of the present invention, there is provided an information processing device comprising:

a photographing section for converting an optical image into an electric image signal;

an image printing section for printing an image by using a printing means according to the electric image signal produced by the photographing section;

a loading portion for removably loading a printing medium on which the image is to be printed by the image printing section;

a detection means for detecting whether the printing medium is loaded to the loading portion; and

a control means for setting an operation mode of the device to a print mode to perform printing by the image printing section when the detection means detects that the printing medium is loaded.

In the fourth aspect of the present invention, there is provided a method of controlling an information processing device, wherein the information processing device comprising a photographing section for converting an optical image into an electric image signal, an image printing section for printing an image by using a printing means according to the electric image signal produced by the photographing section, and a loading portion for removably loading a printing medium on which the image is to be printed by the image printing section; the control method comprising the steps of:

detecting whether the printing medium is loaded to the loading portion; and

setting an operation mode of the device to a print mode to perform printing by the image printing section when the detection step detects that the printing medium is loaded.

With the present invention, by setting and/or canceling the print mode according to the result of detection as to whether the printing medium is set, it is possible to implement a control conforming to the setting state of the printing medium. Thereby, minimizing power consumption and improving operability are performed.

For example, when the printing medium is not set, the print mode is automatically canceled to turn off the print mode standby power or turn off the power of a function portion related to the printing operation, thereby power consumption is reduced. Particularly when a limited power, such as a battery, is used, the present invention can extend the service time of the power. Further, by setting the print mode when the printing medium is set, the apparatus can be automatically transferred to the print mode, thus improving the operability.

The above and other objects, effects, features and advantages of the present invention will become more apparent from the following description of embodiments thereof taken in conjunction with the accompanying drawings.

### BRIEF DESCRIPTION OF THE DRAWINGS

FIG. 1 is a front elevation view of a printer-built-in camera to which the present invention is applicable;

FIG. 2 is a perspective view of the camera in FIG. 1 viewing diagonally from the front thereof;

FIG. 3 is a perspective view of the camera in FIG. 1 viewing diagonally from the back thereof;

FIG. 4 is a perspective view of a medium pack insertable to the camera in FIG. 1;

FIG. 5 is a perspective view showing an arrangement of the main components within the camera in FIG. 1;

FIG. 6 is a perspective view of a printer section in FIG. 5;

FIG. 7 is a perspective view in which a portion of the printer section in FIG. 6 is dislodged;

FIG. 8 is a perspective view of a carriage of the printer in FIG. 6;

FIG. 9 is a perspective view of a component part of a printing medium carrying of the printer section in FIG. 6;

FIG. 10 is a perspective view of a component part of the ink supplying of the printer section in FIG. 6;

FIG. 11 is a plan view illustrating that the medium pack is inserted into a component part of the ink supplying in FIG. 10;

FIG. 12 is a block schematic diagram of the camera section and the printer section of the camera in FIG. 1;

FIG. 13 is a schematic diagram of a signal processing performed in the camera section in FIG. 12;

FIG. 14 is a schematic diagram of a signal processing performed in the printer section in FIG. 12;

FIG. 15 is a functional block diagram showing an essential portion of a control system to explain features of the present invention; and

FIG. 16 is a flow chart explaining the operation of the control system of FIG. 15.

### DETAIL DESCRIPTION OF THE PREFERRED EMBODIMENTS

Embodiments of the present invention will be described below by referring to the accompanying drawings.

In the present specification, “printing” (also referred to as “recording” in some occasions) means not only a condition of forming significant information such as characters and drawings, but also a condition of forming images, designs, patterns and the like on printing medium widely or a condition of processing the printing mediums, regardless of significance or unmeaning or of being actualized in such manner that a man can be perceptive through visual perception.

Also, a “printer” and a “recording apparatus” mean not only one complete apparatus for carrying out a printing but also an apparatus having a function for printing.

Further, the “printing medium” means not only paper used in a conventional printing apparatus but also everything capable of accepting inks, such like fabrics, plastic films, metal plates, glasses, ceramics, wood and leathers, and in the following, will be also represented by a “sheet” or simply by “paper”.

Further, in the present specification, a “camera” indicates an apparatus or device that optically photographs an image and converts the photographed image into electrical signals, and in the following explanation, is also referred to as a “photographing section”.

Still further, an “ink” (also referred to as “liquid” in some occasions) should be interpreted in a broad sense as well as a definition of the above “printing” and thus the ink, by being applied on the printing mediums, shall mean a liquid to be used for forming images, designs, patterns and the like, processing the printing medium or processing inks (for example, coagulation or encapsulation of coloring materials in the inks to be applied to the printing mediums).

Meantime, one embodiment of a head to which the present invention is advantageously employed is the embodiment in which a thermal energy generated by an electrothermal converter is utilized to cause a film boiling to the liquid resulting in a formation of bubbles.

[Basic Structure]

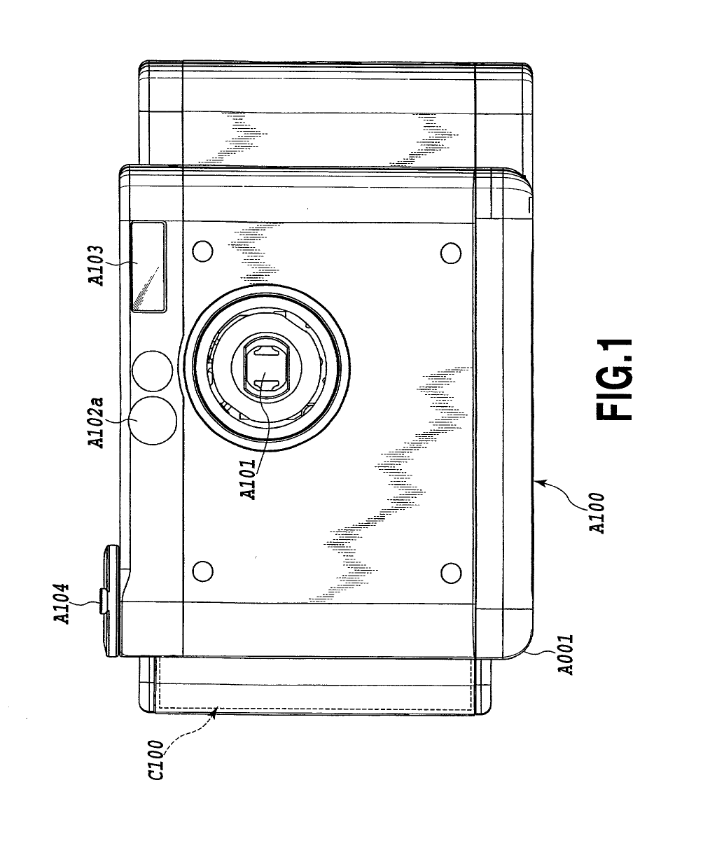

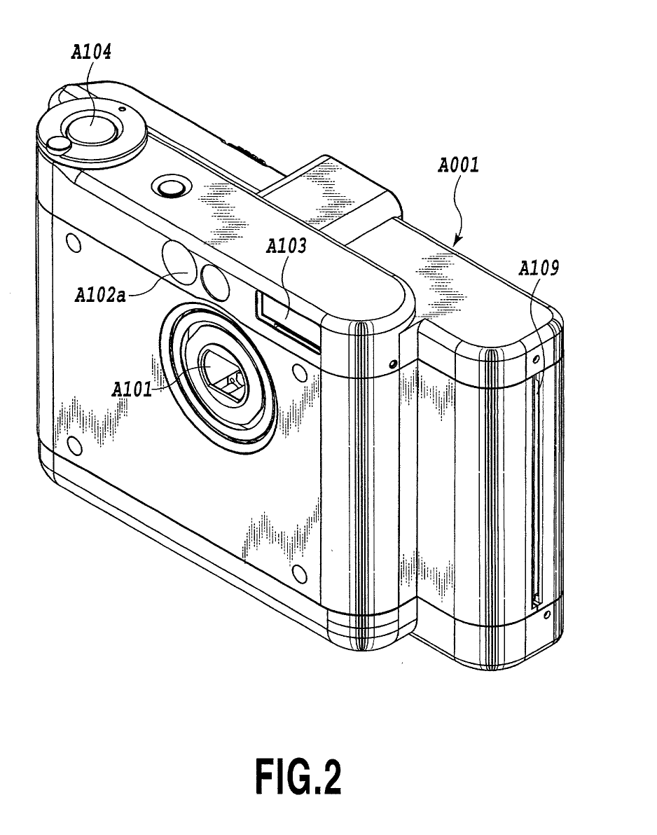

Firstly, a basic structure of a device according to the present invention will be explained in view of FIGS. 1 to 14. The device explained in the present embodiment is constituted as an information processing equipment comprising a photographing section for optically photographing an image and then converting the photographed image into an electric signals (hereinafter, also referred to as “camera section”) and an image recording section for recording image on the basis of thus obtained electric signals (hereinafter, also referred to as “printer section”). Hereinafter, the information processing equipment in the present embodiment is explained in the name of a “printer-built-in camera”.

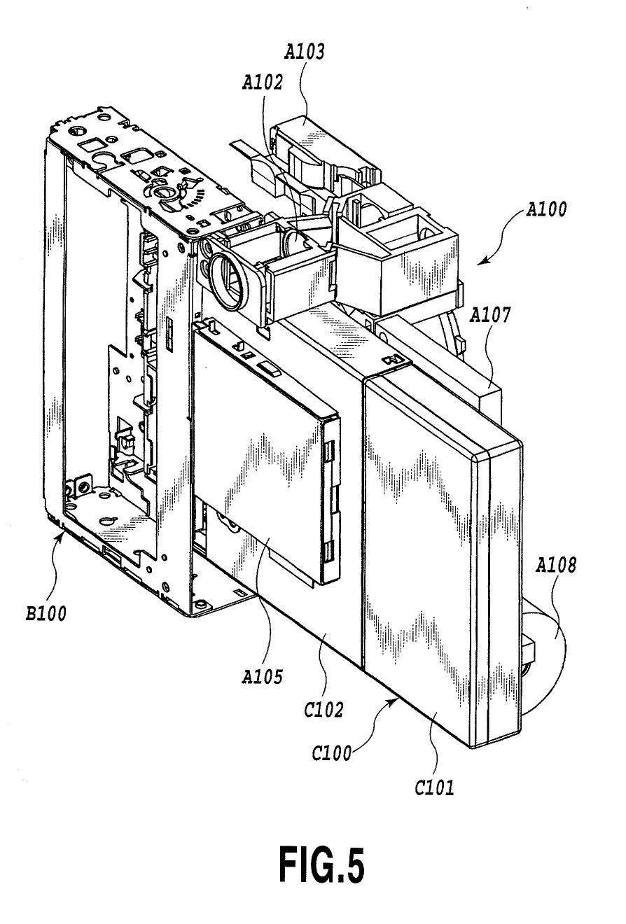

In a main body A001, there is incorporated a printer section (recording apparatus section) B100 at the backside of a camera section A100 in an integral manner. The printer section B100 records an image by using inks and printing mediums which are supplied from a medium pack C100. In the present structure, as apparent from FIG. 5 illustrating the main body A001 viewing from the backside with an outer package removed, the medium pack C100 is inserted at the right hand of the main body A001 in FIG. 5 and the printer section B100 is arranged at the left hand of the main body A001 in FIG. 5. In the case of performing a recording by the printer section B100, the main body A001 can be placed facing a liquid crystal display section A105 up and a lens A101 down. In this recording position, a recording head B120 of the printer section B100, which will be described below, is made to be positioned to eject inks in the downward direction. The recording position can be made to be the same position as that of photographing condition by the camera section A100 and thus is not limited to the recording position as mentioned above. However, in view of a stability of a recording operation, the recording position capable of ejecting the inks in the downward direction is preferred.

There follows the explanations of the basic mechanical structure according to the present embodiment under the headings of 1 as “Camera Section”, 2 as “Medium Pack” and 3 as “Printer Section”, and of the basic structure of the signal processing under the heading of 4 as “Signal Processing”.

1: Camera Section

The camera section A100, which basically constitutes a conventional digital camera, constitutes the printer-built-in digital camera having an appearance in FIGS. 1 to 3 by being integrally incorporated into the main body A001 together with a printer section B100 described below. In FIGS. 1 to 3, A101 denotes a lens; A102 denotes a viewfinder; A102a denotes a window of the viewfinder; A103 denotes a flush; A104 denotes a shutter release button; and A105 denotes a liquid crystal display section (outer display section). The camera section A100, as described below, performs a processing of data photographed by CCD, a recording of the images to a compact flash memory card (CF card) A107, a display of the images and a transmission of various kinds of data with the printer section B100. A109 denotes a discharge part for discharging a printing medium C104 on which the photographed image is recorded. A108, as shown in FIG. 5, is a battery as a power source for the camera section A100 and the printer section B100.

2: Medium Pack

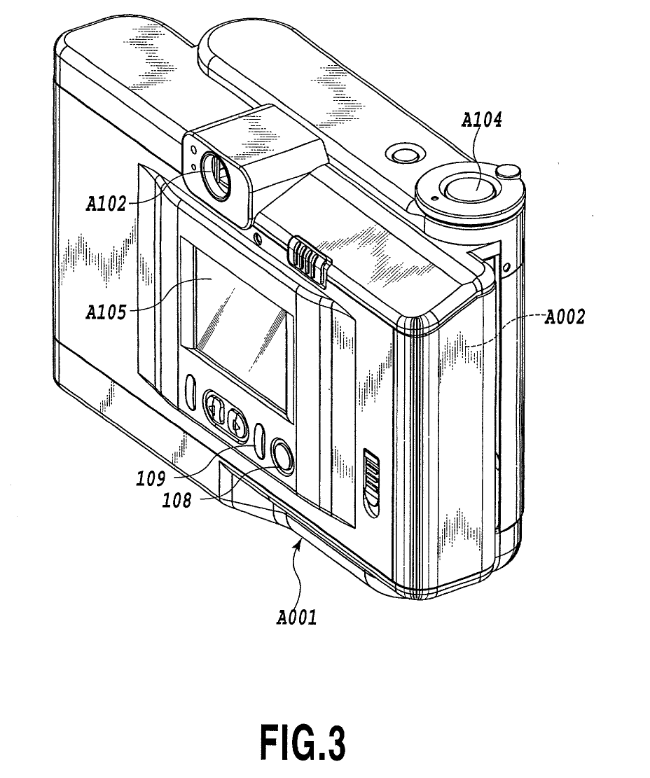

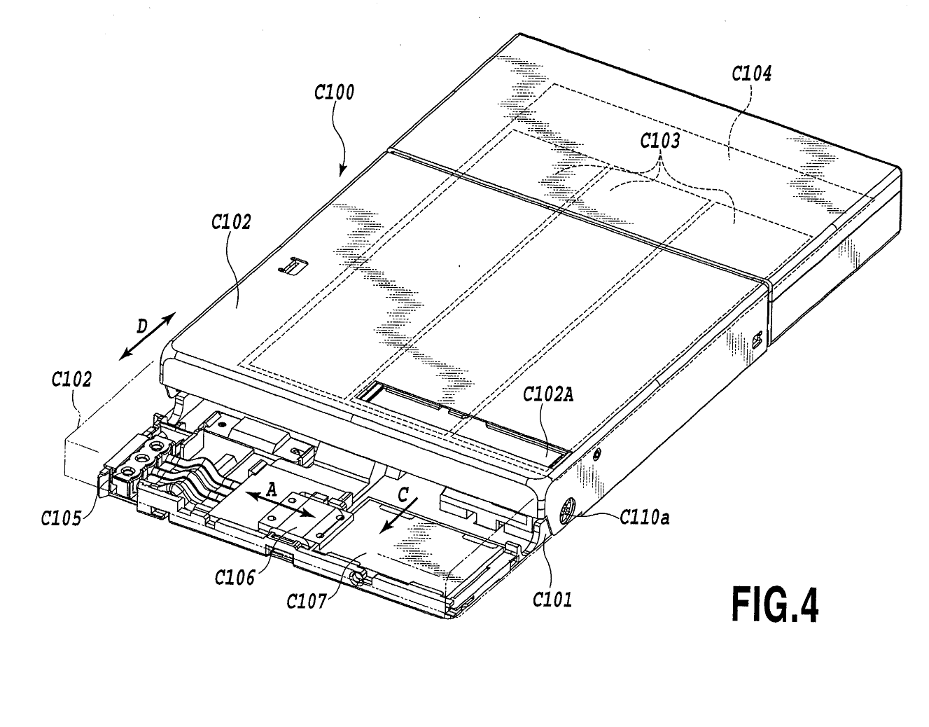

A medium pack C100 is detachable relating to a main body A001 and, in the present embodiment, is inserted through an inserting section A002 of the main body A001 (see FIG. 3), thereby being placed in the main body A001 as shown in FIG. 1. The inserting section A002 is closed as shown in FIG. 3 when the medium pack C100 is not inserted therein, and is opened when the medium pack is inserted therein. FIG. 5 illustrates a status wherein a cover is removed from the main body A001 to which the medium pack C100 is inserted. As shown in FIG. 4, a shutter C102 is provided with a pack body C101 of the medium pack C100 in such manner being slidable in an arrow D direction. The shutter C102, which slides to stay at a position indicated by the two-dots-and-dushed lines in FIG. 4 when the medium pack C100 is not inserted in the main body A001, while slides to a position indicated by the solid lines in FIG. 4 when the medium pack C100 is placed in the main body A001.

The pack body C101 contains ink packs C103 and printing mediums C104. In FIG. 4, the ink packs C103 are held under the printing mediums C104. In the case of the present embodiment, three ink packs C103 are provided so as to separately hold the inks of Y (yellow), M (magenta) and C (cyan), and about twenty sheets of the printing mediums C104 are stored in pile. A suitable combination of those inks and the printing mediums C104 for recording an image is selected to be stored within the medium pack C100. Accordingly, the various medium packs C100 each having a different combination of the inks and the printing mediums (for example, medium packs for super high-quality image; for normal image; and for sealing (seal partitioning)) are prepared and, according to a kind of images to be recorded and an use of the printing medium on which an image is formed, those medium packs C100 are selectively inserted in the main body A001, thereby being able to perform an ensured recording of the images in compliance with the purpose by employing the most suitable combination of the ink and the printing medium. Further, the medium pack C100 is equipped with the below-mentioned EEPROM to which is recorded the identification data such as kinds or remaining amounts of the inks and the printing mediums contained in the medium pack.

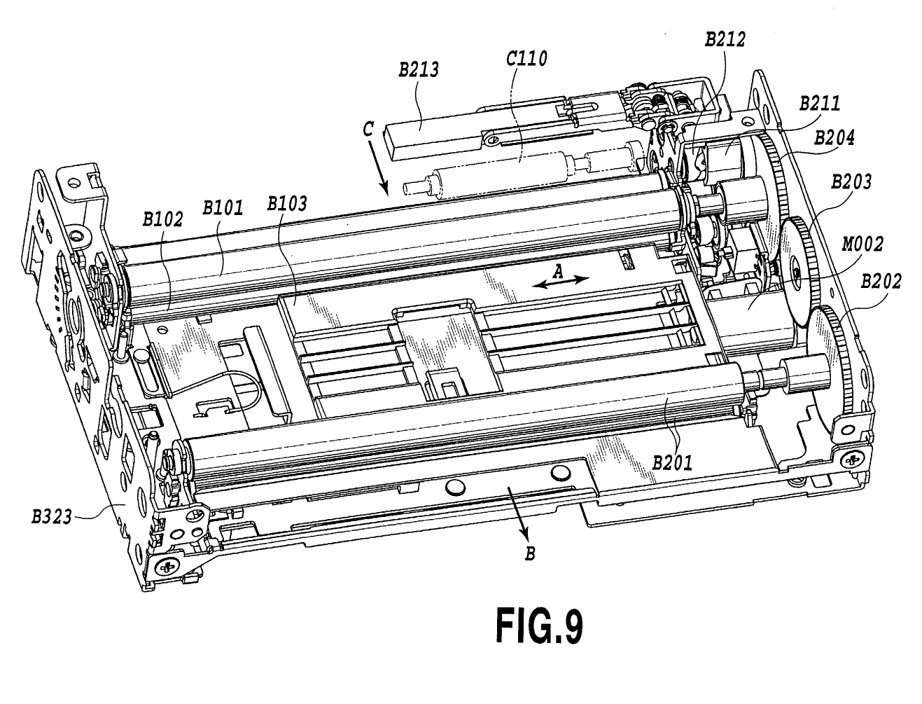

The ink pack C103, upon the medium pack C100 is inserted in the main body A001, is connected to an ink supplying system in the main body A001, through three joints C105 each corresponding to the respective inks of Y, M and C. On the other hand, the printing mediums C104 are separated one by one using a separating mechanism which is not shown in the figures and then sent to a direction of an arrow C by a paper feeding roller C110 (see FIG. 9). A driving force of the paper feeding roller C110 is supplied from an after-mentioned conveying motor M002 (see FIG. 9) provided on the main body A001 through a connecting portion C110a.

Further, the pack body C101 comprises a wiper C106 for wiping a recording head of the after-mentioned printer section, and an ink absorption body C107 for absorbing the abolished inks discharged from the printer section. The recording head in the printer section reciprocates in a direction of the main scanning direction as indicated by an arrow A in such manner describing below. When the medium pack C100 is in the status of being removed from the main body A001, the shutter C102 slides to an position indicated by the two-dots-and-dashed lines in FIG. 4 to protect the joints C105, the wiper C106, the ink absorbing body C107 and so on.

3: Printer Section

The printer section B100 according to the present embodiment is a serial type employing an ink jet recording head. This printer section B100 is explained under the headings of 3-1 “Printing Operating Section”; 3-2 “Printing Medium Carrying”; and 3-3 “Ink Supplying System”, respectively.

3-1: Printing Operating Section

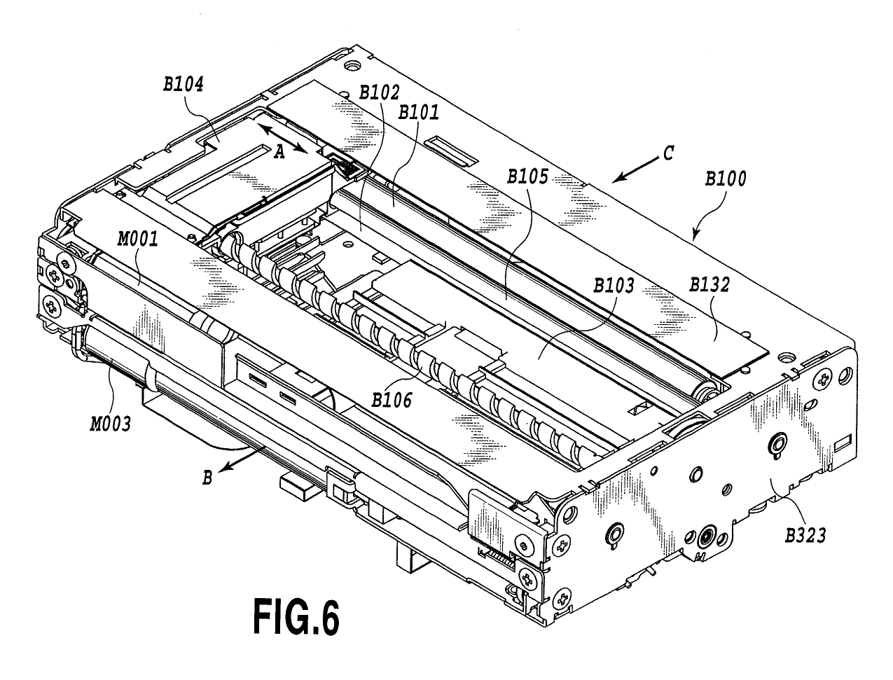

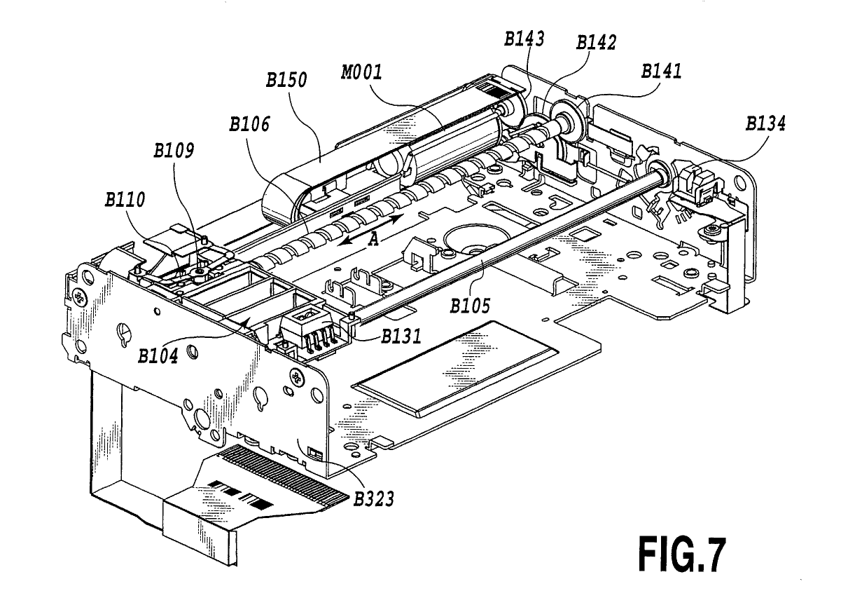

FIG. 6 is a perspective view illustrating the entire printer section B100, and FIG. 7 is a perspective view illustrating the printer section B100 with a part partially taken out.

At a predetermined position in the main body of the printer section B100, a tip portion of the medium pack C100 is positioned when the medium pack C100 is placed in the main body A001 as shown in FIG. 5. The printing medium C104 sent to the direction of an arrow C from the medium pack C100, while being sandwiched between a LF roller B101 and a LF pinch roller B102 of the below-mentioned printing medium carrying system, is carried to the sub-scanning direction indicated by an arrow B on a pressure plate B103. B104 denotes a carriage which reciprocates toward a main scanning direction indicated by an arrow A along a guiding shaft B105 and a leading screw B106.

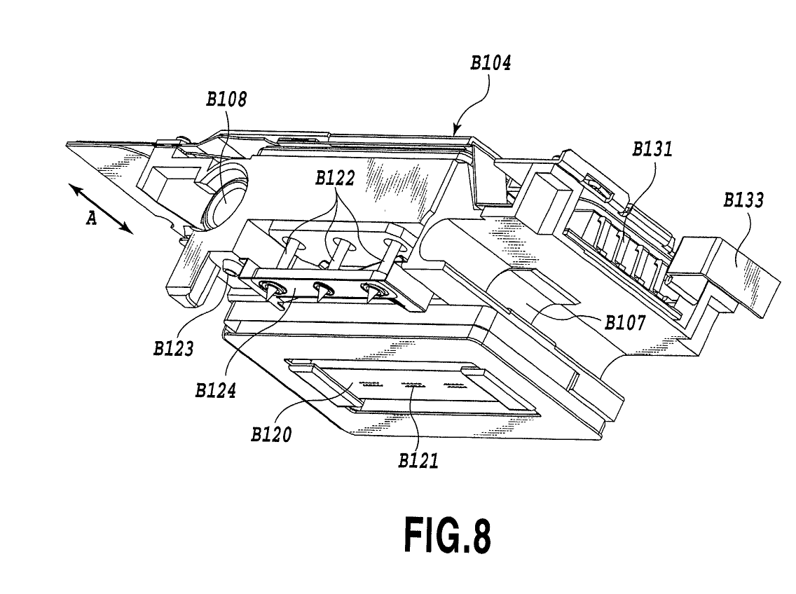

As shown in FIG. 8, the carriage B104 is provided with a bearing B107 for a guiding shaft B105 and a bearing B108 for a leading screw B106. At a fixed position of the carriage B104, as shown in FIG. 7, a screw pin B109 projecting toward an interior of the bearing B108 is installed by a spring B110. A fit of a tip of the screw pin B109 to a helical thread formed on the outer circumference of the leading screw B106 converts a rotation of the leading screw B106 to a reciprocating movement of the carriage B104.

The carriage B104 is equipped with an ink jet recording head B120 capable of ejecting the inks of Y, M and C, and a sub-tank (not shown) for reserving inks to be supplied to the recording head B120. On the recording head B120, a plurality of ink ejection openings B121 (see FIG. 8), which are aligned with the direction crossing with the main scanning direction indicated by the arrow A (in the present embodiment, an orthogonal direction), are formed. The ink ejection openings B121 form nozzles capable of ejecting inks supplied from the sub-tank. As a generating means of energy for discharging the inks, an electro-thermal converting element equipped with each of the nozzles may be used. The electro-thermal converting element generates bubble in the inks within the nozzle by a heating and thus generated foaming energy causes an ejection of the ink droplet from the ink ejection opening B121.

The sub-tank has a capacity smaller than the ink packs C103 contained in the medium pack C100 and made to be a sufficient size for storing a required amount of ink for recording an image corresponding to at least one sheet of printing medium C104. In the sub-tank, there are ink reserving sections for each of the inks of Y, M and C, on each of which is formed the ink supplying section and the negative pressure introducing sections, wherein those ink supplying sections are individually connected to the corresponding three hollow needles B122 and those negative pressure introducing sections are also connected to a common air suction opening B123. Such ink supplying sections, as will be mentioned below, are supplied with inks from the ink packs C103 in the medium pack C100 when the carriage B104 moves to a home position as illustrated in FIG. 6.

In the carriage B104 in FIG. 8, B124 denotes a needle cover which is moved to a position for protecting the needles B122 by the force of the springs as illustrated in FIG. 8 when the needles B122 and the joints C105 are not mated each other, and which releases a protection of the needles B122 by being pushed upwardly against the force of the springs in FIG. 8 when the needles B122 and the joints C105 are mated with each other. A movement position of the carriage B104 is detected by an encoder sensor B131 on the carriage B104 and a linear scale B132 (see FIG. 6) on the main body of the printer section B100. Also, a fact that the carriage B104 moves to the home position is detected by a HP (home position) flag B133 on the carriage B104 and a HP sensor B134 (see FIG. 7) on the main body of the printer section B100.

In FIG. 7, at the both ends of the guiding shaft B105, supporting shafts (not shown) are provided at a position eccentric to the center axis of the guiding shaft. The guiding shaft B105 is turned and adjusted upon the supporting shaft, thereby controlling a height of the carriage 104, resulting in achieving an adjustment of a distance between the recording head B120 and the printing medium C104 on the pressure plate B103. The leading screw B106 is rotatably driven by a carriage motor M001 through a screw gear B141, an idler gear B142 and a motor gear B143. B150 denotes a flexible cable for electrically connecting the after-mentioned controlling with the recording head B120.

The recording head B120 moves together with the carriage B104 toward the main scanning direction indicated by the arrow A and concurrently ejects the inks from the ink ejection openings B121 in accordance with the image signals, thereby recording an image corresponding to one band on the printing medium on the pressure plate B103. An alternate repeat of a recording operation of an image corresponding to one band by such recording head B120 and a conveying operation of the predetermined amount of the printing medium toward the sub-scanning direction indicated by the arrow B by means of the below-mentioned printing medium conveying system enables a sequential recording of the images on the printing medium.

3-2: Printing Medium Carrying

FIG. 9 is a perspective view showing a component of the printing medium conveying system of the printer section B100. In FIG. 9, B201 denotes a pair of paper delivering rollers, and the upper one of the paper delivering rollers B201 in FIG. 9 is driven by a conveying motor M002 through the paper delivering roller gear B202 and a junction gear B203. Likewise, the aforementioned LF roller B101 is driven by the conveying motor M002 through a LF roller gear B204 and the junction gear B203. The paper delivering roller B201 and the LF roller B101 convey the printing medium C104 toward the sub-scanning direction indicated by the arrow B by a driving force of the conveying motor M002 rotating in the forward direction.

On the other hand, when the conveying motor M002 couterrotates, a pressure plate head B213 and a locking mechanism which is not shown are driven through a switching slider B211 and a switching cam B212, while a driven force is transmitted to the paper feeding roller C110 on the medium pack C100. That is, the pressure plate head B213 pressurizes the printing mediums C104, which are piled up within the medium pack C100, in a downward direction in FIG. 4 by a driven force caused by a reverse rotation of the carrying motor M002, through a window portion C102A (see FIG. 4) of a shutter C102 of the medium pack C100. As a result thereof, the printing medium C104 positioned at the lowest position in FIG. 4 is pressed against the feeding roller C110 in the medium pack C100. Also, the locking mechanism which is not shown locks the medium pack C100 to the main body A001 by a driven force caused by a reverse rotation of the carrying motor M002 to inhibit a removal of the medium pack C100. The feeding roller C110 of the medium pack C100 feeds one piece of the printing medium C104 at the lowest position in FIG. 4 toward the direction indicated by the arrow C as a result that the driven force caused by the reverse rotation of the conveying motor M002 is transmitted.

As stated above, only one piece of printing medium C104 is taken out from the medium pack C100 toward the direction indicated by the arrow C by the reverse rotation of the conveying motor M002, and then a forward rotation of the conveying motor M002 conveys the printing medium C104 to the direction indicated by the arrow B.

3-3: Ink Supplying System

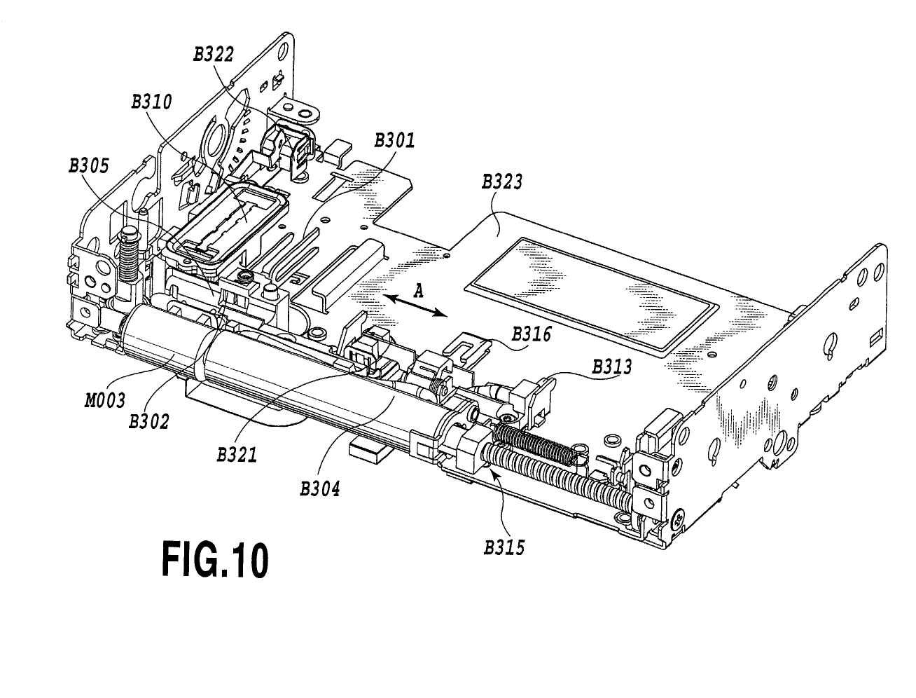

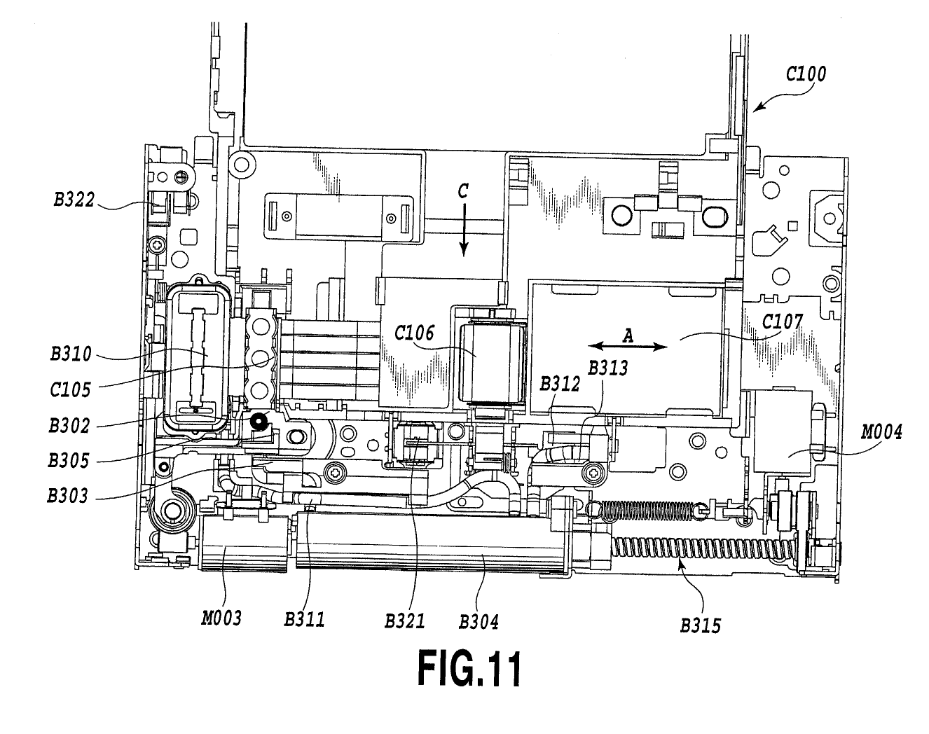

FIG. 10 is a perspective view showing a component part of an ink supplying system of the printer section B100; FIG. 11 is a plane view showing a status that the medium pack C100 is inserted in the component part of the ink supplying system.

A joint C105 of the medium pack C100 installed to the printer section B100 is positioned below the needles B122 (see FIG. 8) on the carriage B104 moved to a home position. The main body of the printer section B100 is equipped with a joint fork B301 (see FIG. 10) positioned below a joint C105, and an upward movement of the joint C105 caused by the joint fork B301 establishes a connection of the joint C105 to the needles B122. As a result thereof, an ink supplying path is formed between the ink packs C103 in the medium pack C100 and the ink supplying sections on the sub-tank on the carriage B104. Further, the main body of the printer section B100 is equipped with a suction joint B302 positioned below an air suction opening B123 (see FIG. 8) of the carriage B104 moved to the home position. This suction joint B302 is connected to a pump cylinder B304 of a pump serving as a negative pressure generating source, through a suction tube B303. The suction joint B302 is connected to the air suction opening B123 on the carriage B104 according to the upward movement caused by a joint lifter B305. In the light of the foregoing, a negative pressure introducing path, between a negative pressure introducing section of the sub-tank on the carriage B104 and the pump cylinder B304, is formed. The joint lifter B305 makes the joint fork B301 move up and down together with the suction joint B302 by a driving power of the joint motor M003.

The negative pressure introducing section of the sub-tank is equipped with a gas-liquid partition member (not shown) which allows a passing through of air but prevents a passing through of the inks. The gas-liquid partition member allows a passing through of the air in the sub-tank to be suctioned through the negative pressure introducing path, and as a result, an ink is supplied to the sub-tank from the medium pack C100. Then, when the ink is sufficiently supplied to the extent that the ink in the sub-tank reaches to the gas-liquid partitioning member, the gas-liquid partitioning member prevents the passing through of the inks, thereby automatically stopping a supply of the inks. The gas-liquid partitioning member is equipped with the ink supplying section in the ink storing sections for the respective inks in the sub-tank, and thus the ink supplying is automatically stopped with respect to each ink storing section.

The main body of the printer section B100 is further equipped with a suction cap B310 capable of capping with respect to the recording head B120 (see FIG. 8) on the carriage B104 which moved to the home position. The suction cap B310 is introduced the negative pressure thereinto from the pump cylinder B304 through suction tube B311, so that the inks can be suctioned and emitted (suction recovery processing) from the ink ejection openings B121 of the recording head B120. Further, the recording head B120, as required, makes the ink, which does not contribute to a recording of an image, ejection into the suction cap B310 (preliminary ejection processing). The ink within the suction cap B310 is discharged into the ink absorption body C107 in the medium pack C110 from the pump cylinder B304 through a waste liquid tube B312 and a waste liquid joint B313.

The pump cylinder B304 constitutes a pump unit B315 together with a pump motor M004 for enabling a reciprocate drive of the pump cylinder. The pump motor M004 also functions as a driving source by which a wiper lifter B316 (see FIG. 10) is moved up and down. The wiper lifter B316 makes the wiper C106 of the medium pack C100 placed in the printer section B100 move upwardly, thereby displacing the wiper C106 to a position capable of a wiping of the recording head B120.

In FIGS. 10 and 11, B321 denotes a pump HP sensor for detecting if an operating position of the pump, which is constituted by the pump cylinder B304, lies at the home position. Further, B322 denotes a joint HP sensor for detecting if the aforementioned ink supplying path and the negative pressure introducing path were formed. Still further, B323 denotes a chassis for constituting a main body of the printer section B100.

4: Signal Processing

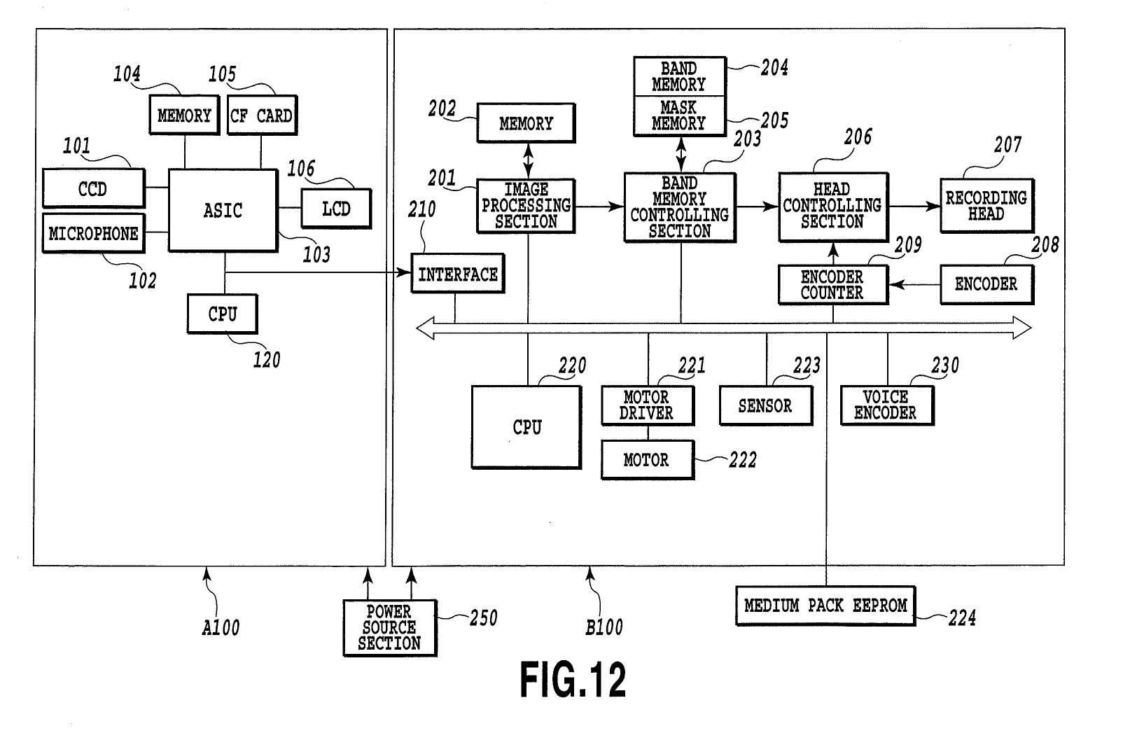

FIG. 12 is a block diagram generally showing the camera section A100 and the printer section B100.

In the camera section A100, 101 denotes a CCD as an image element; 102 denotes a microphone for inputting voice; 103 denotes an ASIC (Application Specific IC) for performing various processings; 104 denotes a first memory for temporary storing an image data and the like; 105 denotes a CF (compact flush) card (corresponding to a “CF card A107”) for recording the photographed image; 106 denotes a LCD (corresponding to a “liquid crystal display section A105”) which displays the photographed image or a replayed image; and 120 denotes a first CPU for controlling the camera section A100.

In the printer section B100, 210 denotes an interface between the camera section A100 and the printer section B100; 201 denotes an image processing section (including a binary processing section for binarizing an image); 202 denotes a second memory to be used in performing the image processing; 203 denotes a band memory controlling section; 204 denotes a band memory; 205 denotes a mask memory; 206 denotes a head controlling section; 207 denotes a recording head (corresponding to the “recording head B120”); 208 denotes an encoder (corresponding to the “encoder sensor B131”); 209 denotes an encoder counter; 220 denotes a second CPU for controlling the printer section B100; 221 denotes motor drivers; 222 denotes motors (corresponding to the motors M001, M002, M003 and M004”); 223 denotes sensors (including the “HP sensors B134, B321 and B322”); 224 denotes an EEPROM contained in the medium pack C100; 230 denotes a voice encoder section and 250 denotes a power source section for supplying electric power to the entire device (corresponding to the “battery A108”).

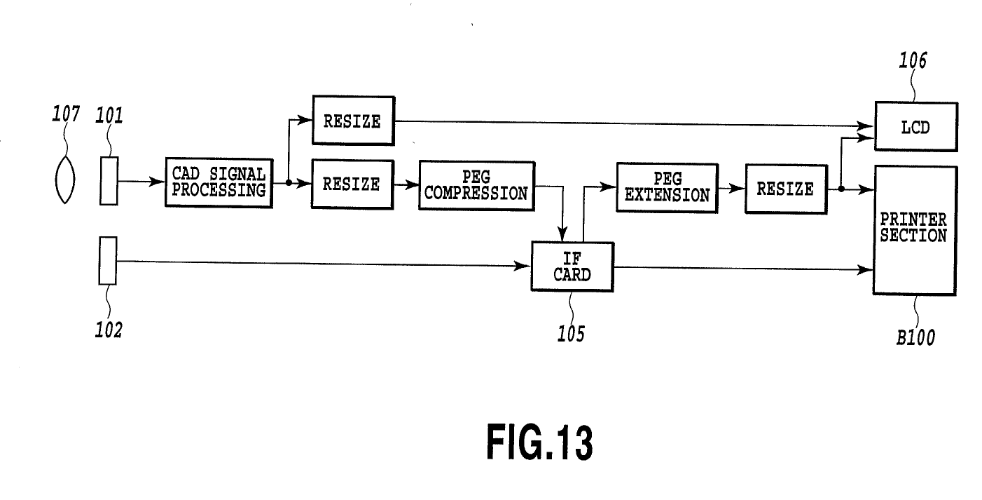

FIG. 13 is a schematic diagram showing a signal processing in the camera section A100. In a photographing mode, an image photographed by the CCD 101 through a lens 107 is signal-processed (CCD signal processing) by ASIC 103 and then is converted to YUV intensity with two-color-different signal. Further, the photographed image is resized to a predetermined resolution and recorded on a CF card 105 using a compression method by JPEG, for example. Also, a voice is inputted through a microphone 102 and stored in the CF card 105 through the ASIC 103. A recording of the voice can be performed in such manner recording at the same time of photographing, or after photographing so called an after-recording. In a replay mode, the JPEG image is read out from the CF card 105, extended by the JPEG through the ASIC 103 and further resized to be a resolution for displaying, thereby being displayed on the LCD 106.

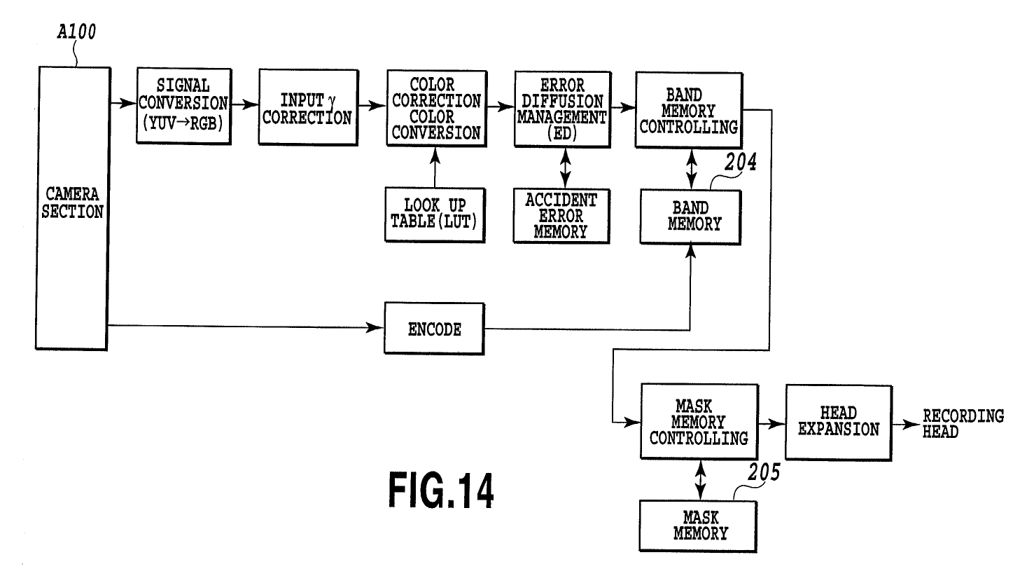

FIG. 14 is a schematic diagram showing a signal processing performed in the printer section B100.

An image replayed on the camera section A100, that is the image being read out from the CF card 105, is extended by the JPEG through ASIC 103 as shown in FIG. 13 to resize a resolution to a suitable size for printing. Then, the resized image data (YUV signal), through an interface section 210, is transferred to the printer section B100. As shown in FIG. 14, the printer section B100 performs an image processing of an image data transferred from the camera section A100 by an image processing section 201, thereby performing an conversion of the image data to a RGB signal, an input γ correction in accordance with the features of a camera, a color correction and a color conversion using a look up table (LUT), and an conversion to a binarized signal for printing. When performing the binarizing processing, in order to perform an error diffusion (ED), a second memory 202 is utilized as an error memory. In the case of the present embodiment, though a binarizing processing section in the image processing section 201 performs the error diffusion processing, in other processing may be performed such as a binarizing processing using a dither pattern. The binarized printing data is stored temporary in the band memory 204 by a band memory controlling section 203. An encoder pulse from the encoder 208 enters into the encoder counter 209 of the printer section B100 every time the carriage B104 carrying the recording head 207 and the encoder 208 moves a certain distance. Then, in sync with this encoder pulse, a printing data is read out from the band memory 204 and the mask memory 205, and, based on thus obtained printing data, the head controlling section 206 controls the recording head 207 to perform a recording.

A band memory shown in FIG. 14 is explained as below.

A plurality of nozzles in the recording head 207, for example, is formed in array so as to achieve a density of 1200 dpi (dots/inch). For recording the image by using such recording head 207, upon performing one scanning by the carriage, it is preferred to previously prepare a recording data (a recording data corresponding to one scanning) corresponding to the number of nozzles in the sub-scanning direction (hereinafter, also referred to as a “column (Y direction)”) and a recording data corresponding to the recording area in the scanning direction (hereinafter, also referred to as a “row (X direction)”, respectively. The recording data is created in the image processing section 201 and then is temporary stored in the band memory 204 by the band memory controlling section 203. After the recording data corresponding to one scan is stored in the band memory 204, the carriage is scanned in the main scanning direction. In so doing, an encoder pulse inputted by the encoder 208 is counted by the encoder counter 209 and, in accordance with this encoder pulse, a recording data is read out from the band memory 204. Then, on the basis of the image data, ink droplets are ejected from the recording head 207. In the case that a bidirectional recording system wherein an image is recorded upon outward scanning and homeward scanning (outward recording and homeward recording) of the recording head 207 is employed, the image data is read out from the band memory 204 depending on the scanning direction of the recording head 207. For example, an address of the image data read out from the band memory 204 is increased sequentially when the outward recording is performed, while an address read out from the band memory 204 is decreased sequentially when the homeward scanning is performed.

In a practical sense, a writing of an image data (C, M and Y) created by the image processing section 201 into the band memory 204 and a subsequent preparation of the image data corresponding to one band enable a scanning of the recording head 207. Then, the image data is read out from the band memory 204 subsequent to a scan of the recording head 207, so that the recording head 207 records the image on the basis of the image data. While the recording operation, an image data to be recorded next is created at the image processing section 201 and thus created image data is written into an area of the band memory 204 corresponding to a recording position.

As has been stated above, the band memory controlling is carried out in such manner that a writing operation in which an recording data (C, M, Y) created by the image processing section 201 is written into the band memory 204 and a reading operation for transferring the recording data (C, M, Y) to the head controlling section 206 in accordance with a scanning movement of the carriage are changed over.

A mask memory controlling in FIG. 14 is explained as below.

This mask memory controlling is required when a multipass recording system is employed. In using the multipass recording system, the recording image corresponding to one line which has a width corresponding to a length of the nozzle array of the recording head 207 is divided to a plurality of scanning of the recording head 207 to record. That is, conveying amount of the printing medium to be intermittently carried to the sub-scanning direction is made to be 1/N of a length of the nozzle array. For example, when N=2, a recording image corresponding to one line is divided into two scans to record (two-pass recording), and when N=4, a recording image corresponding to one line is divided into four scans to record (four-pass recording). In similar fashion, when N=8, it becomes eight-pass recording, and when N=16, it becomes sixteen-pass recording. Therefor, the recording image corresponding to one line will be completed by a plurality of scans of the recording head 207.

Practically, a mask data for assigning the image data to a plurality of scans of the recording head 207 is stored in the mask memory 205, and then based on a conjunction (AND) data between the mask data and the image data, the recording head 207 ejects inks to record the image.

Also, in FIG. 14, a voice data stored in the CF card 105, alike the image data, is transferred to the printer section B100 through an interface 210 by the ASIC 102. The voice data transferred to the printer section B100 is encoded at the voice encoder 230 and then recorded with the image to be printed as a code data. When there is no necessity to input a voice data into a printing image, or when printing an image without a voice data, of course, the encoded voice data is not printed but only the image is printed.

In the present embodiment, the present invention has been explained as a printer-built-in camera integral with a camera section A100 and printer section B100. However, it would be possible to make each of the camera section A100 and the printer section B100 a separate device and to form in a similar manner as a structure in which those devices are connected each other by the interface 210 to realize a similar function.

[Configuration of Control System]

The configuration of the control system, which is characteristic of the present invention, will be detailed by referring to the accompanying drawings.

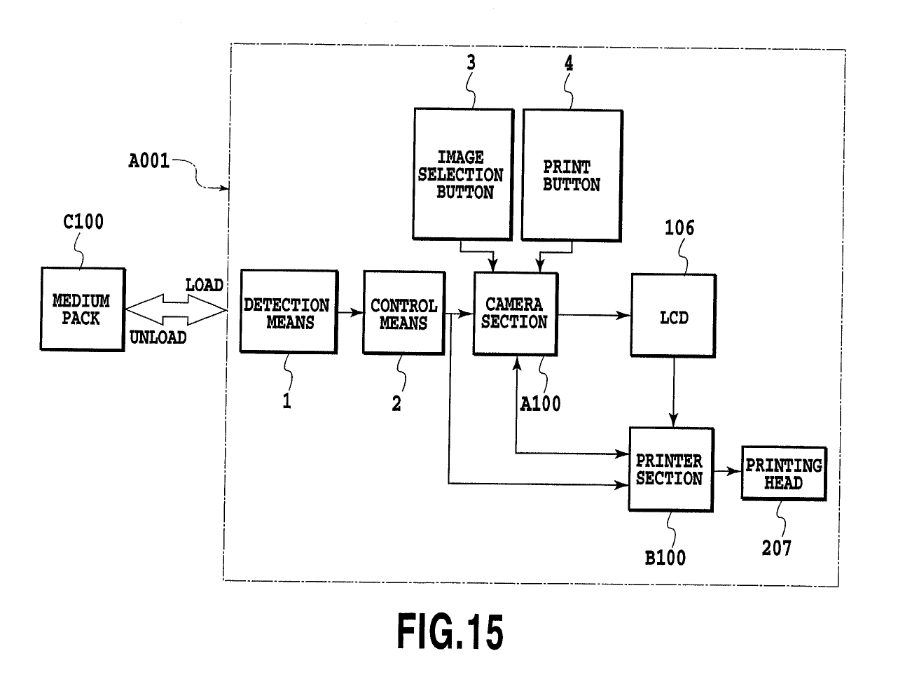

FIG. 15 is a functional block diagram showing the configuration of a control system that is operated according to whether a medium pack C100 is attached or detached. In FIG. 15, for ease of explanation, the camera section A100 and the LCD 106 are shown separate and the printer section B100 and the recording head 207 are also shown separate. The camera section A100, the printer section B100 and the LCD 106 can be turned on or off individually by a control means 2 turning on or off the power of these sections. 1 denotes a detection means which detects when the medium pack C100 is set to the main body A001 and sends to the control means 2 a trigger signal representing the detection result. The detection means 1 may be realized, for example, by using a microswitch that is operated when the medium pack C100 is loaded, or by providing electrodes to the medium pack C100 and a medium pack loading portion of the main body A001 to detect their electrical connection and therefore the loading or unloading operation of the medium pack C100. According to the trigger signal from the detection means 1 and the operation states of an image selection button 3 and a print button 4, the control means 2 of FIG. 15 controls the camera section A100, the printer section B100 and the LCD 106 as described later. The image selection button 3, as a select specify means, used to select and specify an image to be printed. The print button 4, as a print specify means, used to instruct the printer section B100 to print the selected image. These button 3 and 4 are operated by the user. When the print button 4 is pressed to specify the printing of an image, the image selected by the image selection button 3 is printed.

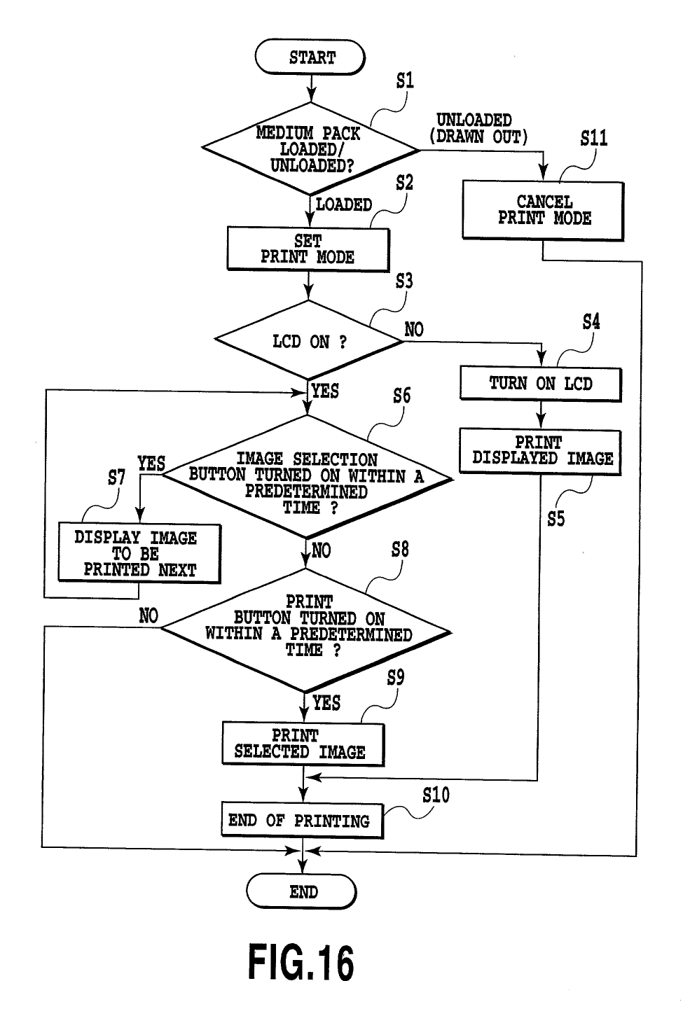

FIG. 16 is a flow chart explaining the function of the control means 2. The control means 2 checks the trigger signal from the detection means 1 to decide whether the medium pack C100 is inserted or withdrawn (step S1).

When the medium pack C100 is loaded but the print mode is not yet set, the operation mode is set to the print mode to turn on the power of the printer section B100 (step S2). The print mode is an operation mode to print an image displayed on the LCD 106. Then, it is checked whether the power of the LCD 106 is on. When the LCD 106 is off, the camera section A100 enters a playback mode which turns on the power of the LCD 106 (step S4) which then displays an image to be printed. At the same time, the image data is transferred to the printer section B100. The printer section B100, based on the image data received, prints the image displayed on the LCD 106 (step S5). The image displayed on the LCD 106 can be inputted from the CF card 105 and is printed on the printing medium drawn out of the medium pack C100 by using the recording head (printing head) 207. After the image data is transferred from the camera section A100 to the printer section B100, the LCD 106 and the camera section A100 are turned power off as the printer section B100 performs the printing operation. When the image displayed on the LCD 106 is all printed out, a print termination processing is performed (step S10). The print termination processing may include turning off the power of the printer section B100.

These steps S2, S3, S4, S5, S10 automatically set the print mode and quickly print the image that is displayed on the LCD 106 in the playback mode. Hence, the print mode in this case can be called a quick print mode. The quick print mode may, for example, omit the setting of the number of printing copies and print one copy of each of all the displayed images selected for printing.

In the decision of step S3, when the LCD 106 is on, the playback mode of the camera section A100 displays an image to be printed on the LCD 106, the same as described case. At this time, the image selection button 3 is ON-operated to change the display image on the LCD 106 sequentially in a predetermined order to select an image to be printed (step S6, S7). If the image selection button 3 is not ON-operated within a predetermined time duration, the program waits for the ON-operation of the print button 4. Upon the ON-operation of the print button 4, an image to be printed is determined. Thus the printer section B100, based on the image data transferred from the camera section A100, prints the image displayed on the LCD 106 (step S9). Then, after the image data has been transferred from the camera section A100 to the printer section B100, the LCD 106 and the camera section A100 are turned power off as the printer section B100 performs the printing operation. When the image displayed on the LCD 106 has all been printed, the print termination processing is carried out (step S10). The print termination processing may include turning off the power of the printer section B100.

In addition to the selection of an image to be printed by using the image selection button 3, the print mode in these steps S2, S3 and S6 to S10 may allow the user to set the number of printing copies. By repeating the ON-operation of the image selection button 3 and the print button 4, it is possible to select and print one image at a time. In this case, each time the printing of one image is finished, the following operations are repeated, i.e., setting the camera section A100 to the playback mode, ON-operating the image selection button 3 to select an image displayed on the LCD 106 to be printed next, and finalizing the image to be printed and printing it by ON-operating the print button 4.

In the decision of step S8, when the print button 4 is not ON-operated within a predetermined time duration, the processing of FIG. 16 is forcibly aborted. In that case, a control is performed to cancel the print mode and turn off the power of the printer section B100 to minimize the power consumption of the apparatus.

Further, in the decision of step S1, when the medium pack C100 is drawn out (unloaded) (step S11), the print mode is canceled and the power of the printer section B100 is turned off to cut power supply to all electric systems in the printer section B100.

(Other Embodiments)

The printing medium may be accommodated in a dedicated medium pack and set in the main body A001. The construction of a container for accommodating the printing medium is not limited to that of the medium pack C100 used in this embodiment. The printing medium may also be directly set in the main body A001. In that case, the detection means 1 directly detects the setting of the printing medium.

The control means need only be able to set or reset at least the print mode according to the result of detection by the detection means 1.

Further, in the embodiment above, an information processing equipment comprising a photographing section functioning as a camera and an image recording section for recording image is described as an example case, the present invention is not limited to the construction described above and may be applied to a host device and to an image printing apparatus which, based on an image signal supplied from memory or the like, prints an image on a printing medium.

The present invention has been described in detail with respect to preferred embodiments, and it will now be apparent from the foregoing to those skilled in the art that changes and modifications may be made without departing from the invention in its broader aspects, and it is the intention, therefore, in the appended claims to cover all such changes and modifications as fall within the true spirit of the invention.

What is claimed is:

1. An image printing apparatus capable of printing a image on a printing medium when an operation mode is selected as a print mode, comprising:
a detection means for detecting whether the printing medium is set; and
a control means for setting and/or canceling the print mode according to a result of detection by the detection means.

2. The image printing apparatus according to claim 1, wherein, the control means sets the print mode when the detection means detects that the printing medium is set.

3. The image printing apparatus according to claim 1, wherein, the control means cancels the print mode when the detection means detects that the printing medium is not set.

4. The image printing apparatus according to claim 1, wherein, the control means turns off a standby power of the print mode when it cancels the print mode.

5. The image printing apparatus according to claim 1, wherein, the printing medium, as it is accommodated in a container, is set and the detection means detects whether the container is set.

6. The image printing apparatus according to claim 1, further comprising a display means for displaying an image to be printed, wherein the control means controls the display means according to a result of detection by the detection means.

7. The image printing apparatus according to claim 6, wherein, the control means performs an on/off control on a power of the display means according to a result of detection by the detection means.

8. The image printing apparatus according to claim 1, further comprising a photographing section capable of obtaining an image to be printed.

9. The image printing apparatus according to claim 8, wherein, the control means controls the photographing section according to a result of detection by the detection means.

10. The image printing apparatus according to claim 9, wherein, the control means performs an on/off control on a power of the photographing section.

11. The image printing apparatus according to claim 1, wherein, an ink jet printing head capable of ejecting ink is used to print an image.

12. The image printing apparatus according to claim 11, wherein, the ink jet printing head has an electrothermal transducer which generates a thermal energy for ejecting ink.

13. A method of controlling an image printing apparatus capable of printing a image on a printing medium when an operation mode is set as a print mode, comprising the steps of:
setting and/or canceling a print mode according to a result of detection as to whether the printing medium is set.

14. An information processing device comprising:
a photographing section for converting an optical image into an electric image signal;
an image printing section for printing an image by using a printing means according to the electric image signal produced by the photographing section;
a loading portion for removably loading a printing medium on which the image is to be printed by the image printing section;
a detection means for detecting whether the printing medium is loaded to the loading portion; and
a control means for setting an operation mode of the device to a print mode to perform printing by the image printing section when the detection means detects that the printing medium is loaded.

15. The information processing device according to claim 14, further comprising a power control means for turning on or off powers of the photographing section and the image printing section; wherein,
when the detection means detects that the printing medium is loaded, the control means sets the operation mode of the device to the print mode to perform printing by the image printing section and the power control means turns on the power of the image printing section.

16. The information processing device according to claim 14, wherein, when the detection means detects that the printing medium is removed from the loading section, the control means cancels the print mode.

17. The information processing device according to claim 14, further comprising a selection instruction means for specifying a selection of an image to be printed by the image printing section and a printing instruction means for specifying a printing of an image by the image printing section; wherein,
when the printing of an image is specified by the printing instruction means, the image specified by the selection instruction means is printed by the printing means.

18. The information processing device according to claim 17, wherein, when the printing instruction means does not specify the printing of an image within a predetermined time after the control means has set the print mode following the loading of the printing medium, the control means cancels the print mode.

19. The information processing device according to claim 14, further comprising a display section for displaying an image to be printed; wherein,
when the control means sets the print mode following the loading of the printing medium while a power of the display section is off, the control means turns on the power of the display section.

20. A method of controlling an information processing device, wherein the information processing device comprising a photographing section for converting an optical image into an electric image signal, an image printing section for printing an image by using a printing means according to the electric image signal produced by the photographing section, and a loading portion for removably loading a printing medium on which the image is to be printed by the image printing section; the control method comprising the steps of:
detecting whether the printing medium is loaded to the loading portion; and
setting an operation mode of the device to a print mode to perform printing by the image printing section when the detection step detects that the printing medium is loaded.

21. The method of controlling an information processing device according to claim 20, wherein, the device is capable of turning on or off powers of the photographing section and the image printing section; further comprising the steps of:
turning on the power of the image printing section when the print mode is set following the detection of the loading of the printing medium.

22. The method of controlling an information processing device according to claim 20, wherein, when it is detected that the printing medium is removed from the loading section, the print mode is canceled.

23. The method of controlling an information processing device according to claim 20, further comprising:
a selection step for specifying a selection of an image to be printed by the image printing section; and
a printing instruction step for specifying a printing of an image; wherein,
when the printing of an image is specified, the image specified by the selection step is printed by the printing means.

24. The method of controlling an information processing device according to claim 23, wherein, when the printing of an image is not specified within a predetermined time after the print mode is set following the loading of the printing medium, the print mode is canceled.
